(19) United States
(12) Patent Application Publication
(10) Pub. No.: US 2023/0360118 A1
(43) Pub. Date: Nov. 9, 2023

(54) ELECTRONIC APPARATUS AND CONTROLLING METHOD THEREOF

(71) Applicant: SAMSUNG ELECTRONICS CO., LTD., Suwon-si (KR)

(72) Inventors: Seonguk SEO, Suwon-si (KR); Jieun SHIN, Suwon-si (KR); Jihye HA, Suwon-si (KR); Sunah KIM, Suwon-si (KR)

(73) Assignee: SAMSUNG ELECTRONICS CO., LTD., Suwon-si (KR)

(21) Appl. No.: 18/137,206

(22) Filed: Apr. 20, 2023

(30) Foreign Application Priority Data
May 4, 2022 (KR) 10-2022-0055487
Jul. 20, 2022 (KR) 10-2022-0089732

(51) Int. Cl. G06Q 30/08; G06N 20/00; G06N 7/01

(52) U.S. Cl. CPC G06Q 30/08; G06N 20/00; G06N 7/01

(57) ABSTRACT

The electronic apparatus disclosed includes a memory storing an artificial intelligence model predicting the minimum winning price in a real time bidding and instructions, and processors configured to, acquire information on a plurality of auction histories including at least one auction history of a first auction type and at least one auction history of a second auction type, generate the minimum winning price probability distribution for entire of the plurality auction histories, based on the minimum winning price probability distribution for entire of the plurality auction histories, generate a conditional minimum winning price probability distribution for each of the plurality of auction histories, and train the artificial intelligence model by using auction attribute information for each of the plurality of auction histories as an independent variable, and using the conditional minimum winning price probability distribution for each of the plurality of auction histories as a dependent variable.

### CROSS-REFERENCE TO RELATED APPLICATIONS

The present application claims priority from Korean Patent Application No. 10-2022-0055487, filed on May 4, 2022, and Korean Patent Application No. 10-2022-0089732, filed on Jul. 20, 2022, in the Korean Intellectual Property Office, the disclosures of which are incorporated herein by their entireties.

### BACKGROUND OF THE DISCLOSURE

### 1. Field

The disclosure relates to an electronic apparatus and a controlling method thereof, and more particularly, to an electronic apparatus training an artificial intelligence model predicting the minimum winning price in a real time bidding, and a controlling method thereof.

### 2. Description of the Related Art

The scale of the digital advertising market is getting bigger. Digital advertising means exposing an advertising content of an advertiser through a publisher, for the purpose of attracting attention of a user or a customer (referred to as a user hereinafter) who accessed the publisher online.

Recently, in auctions in digital advertising, a method of real time bidding (RTB) is mainly used. Real time bidding means that an auction proceeds when a user accesses a publisher and a trade of an advertisement area takes place between the publisher and an advertiser who won the auction, and the advertising content of the advertiser who won the auction is exposed to the user at a time close to real time (e.g.: 200 ms, etc.).

In the real time bidding method, an automatized advertising system including a demand side platform (DSP) is needed. Here, the demand side platform (DSP) is a server (or a system) automatized for immediately responding to a bidding request in place of an advertiser, and if there is a bidding request indicating that an auction started, an advertiser can determine the bid price based on a desired user or time, region, unit price, etc. within a very short time close to real time, and bid for the auction at the determined bid price. As described above, the DSP performs a role of helping an advertiser so that a trade between a publisher and the advertiser takes place automatically.

Here, for maximizing advertising efficiency, a problem regarding price optimization exists, which is related to at how much a bid price of an advertiser should be determined by the DSP.

Meanwhile, price prediction models in conventional real time biddings could predict a winning price by receiving input of information on the first price auction type or predict a winning price by receiving input of information on the second price auction type. Accordingly, there was inconvenience of having to train different models according to auction types, and divide received auction attribute information and input into each model.

Also, the conventional price prediction models were trained based on winning price information for the entire auction histories or some clusters, but the models were not trained based on the winning price information for each auction history, and thus there was a problem that the models could not predict a price correctly.

### SUMMARY

The disclosure was devised for resolving the aforementioned conventional problems, and the purpose of the disclosure is in providing an electronic apparatus training an artificial intelligence model to predict the minimum winning price when auction information is input without dividing auction types in a real time bidding, and a controlling method thereof.

Also, another purpose of the disclosure is in providing an electronic apparatus that predicts the correct minimum winning price by generating a winning price probability distribution for each learning data for training an artificial intelligence model, and a controlling method thereof.

Meanwhile, the tasks sought to be resolved by the technical idea of the disclosure are not limited to the tasks mentioned above, and other tasks that were not mentioned would be clearly understood by a person skilled in the art from the descriptions below.

An electronic apparatus training an artificial intelligence model predicting the minimum winning price in a real time bidding according to an embodiment of the disclosure for achieving the aforementioned purposes includes a memory storing the artificial intelligence model and at least one instruction, and a processor which is connected with the memory and controls the electronic apparatus, wherein the processor is configured to, by executing the at least one instruction, acquire information on a plurality of auction histories including at least one auction history of a first auction type and at least one auction history of a second auction type, generate the minimum winning price probability distribution for entire of the plurality auction histories, based on the minimum winning price probability distribution for entire of the plurality auction histories, generate a conditional minimum winning price probability distribution for each of the plurality of auction histories, and train the artificial intelligence model by using auction attribute information for each of the plurality of auction histories as an independent variable, and using the conditional minimum winning price probability distribution for each of the plurality of auction histories as a dependent variable.

The first auction type may be a first-price auction, and the second auction type may be a second-price auction.

The information on the plurality of auction histories may include at least one of auction attribute information, information on bid prices, information on whether the auctions were won, or information on winning prices, and the auction attribute information may include at least one of information on auction types, information on advertisements, or information on users.

The processor may acquire information on a section wherein the minimum winning price exists from each of the information on the at least one auction history of the second auction type, and based on the acquired information on the section, generate the minimum winning price probability distribution for entire of the plurality auction histories.

The processor may accumulate the acquired information on the section, and generate a bid winning probability function for a bid price, based on the information on the at least one auction history of the first auction type, update the bid winning probability function, and based on the updated bid winning probability function, generate the minimum winning price probability distribution for entire of the plurality auction histories.

The processor may, based on one auction history among the plurality of auction histories being an auction history that won a bid in the first auction type, acquire a conditional minimum winning price probability distribution for the one auction history by using a probability value for a price higher than or equal to the bid price included in the information on the one auction history as 0 in the minimum winning price probability distribution for entire of the plurality auction histories.

The processor may, based on one auction history among the plurality of auction histories being an auction history that won a bid in the second auction type, acquire a conditional minimum winning price probability distribution for the one auction history by using a probability value for the winning price included in the information on the one auction history as 1 in the minimum winning price probability distribution for entire of the plurality auction histories.

The processor may, based on one auction history among the plurality of auction histories being an auction history that lost in a bid in the first auction type or the second auction type, acquire a conditional minimum winning price probability distribution for the one auction history by using a probability value for a price lower than or equal to the bid price included in the information on the one auction history as 0 in the minimum winning price probability distribution for entire of the plurality auction histories.

A controlling method of an electronic apparatus training an artificial intelligence model predicting the minimum winning price in a real time bidding according to an embodiment of the disclosure includes the operations of acquiring information on a plurality of auction histories including at least one auction history of a first auction type and at least one auction history of a second auction type, generating the minimum winning price probability distribution for entire of the plurality auction histories, based on the minimum winning price probability distribution for entire of the plurality auction histories, generating a conditional minimum winning price probability distribution for each of the plurality of auction histories, and training the artificial intelligence model by using auction attribute information for each of the plurality of auction histories as an independent variable, and using the conditional minimum winning price probability distribution for each of the plurality of auction histories as a dependent variable.

The first auction type may be a first-price auction, and the second auction type may be a second-price auction.

The information on the plurality of auction histories may include at least one of auction attribute information, information on bid prices, information on whether the auctions were won, or information on winning prices, and the auction attribute information may include at least one of information on auction types, information on advertisements, or information on users.

In the operation of generating the minimum winning price probability distribution, information on a section wherein the minimum winning price exists may be acquired from each of the information on the at least one auction history of the second auction type, and based on the acquired information on the section, the minimum winning price probability distribution for entire of the plurality auction histories may be generated.

In the operation of generating the minimum winning price probability distribution, the acquired information on the section may be accumulated, and a bid winning probability function for a bid price may be generated, based on the information on the at least one auction history of the first auction type, the bid winning probability function may be updated, and based on the updated bid winning probability function, the minimum winning price probability distribution for entire of the plurality auction histories may be generated.

In the operation of generating the conditional minimum winning price probability distribution for each of the plurality of auction histories, based on one auction history among the plurality of auction histories being an auction history that won a bid in the first auction type, a conditional minimum winning price probability distribution for the one auction history may be acquired by using a probability value for a price higher than or equal to the bid price included in the information on the one auction history as 0 in the minimum winning price probability distribution for entire of the plurality auction histories.

In a non-transitory computer-readable recording medium including a program executing a controlling method of an electronic apparatus training an artificial intelligence model predicting the minimum winning price in a real time bidding according to an embodiment of the disclosure, the controlling method of the electronic apparatus may include the operations of acquiring information on a plurality of auction histories including at least one auction history of a first auction type and at least one auction history of a second auction type, generating the minimum winning price probability distribution for entire of the plurality auction histories, based on the minimum winning price probability distribution for entire of the plurality auction histories, generating a conditional minimum winning price probability distribution for each of the plurality of auction histories, and training the artificial intelligence model by using auction attribute information for each of the plurality of auction histories as an independent variable, and using the conditional minimum winning price probability distribution for each of the plurality of auction histories as a dependent variable.

### BRIEF DESCRIPTION OF THE DRAWINGS

FIG. 1 is a block diagram for illustrating a configuration of an electronic apparatus according to an embodiment of the disclosure;

FIG. 2 is a diagram for illustrating an artificial intelligence model according to an embodiment of the disclosure;

FIG. 3 is a diagram for illustrating information on an auction history according to an embodiment of the disclosure;

FIG. 4 is a flow chart for illustrating a method for generating a winning price probability distribution according to an embodiment of the disclosure;

FIG. 5 is a diagram for illustrating a cumulative distribution function according to an embodiment of the disclosure;

FIG. 6 is a diagram for illustrating the minimum winning price probability distribution according to an embodiment of the disclosure;

FIG. 7 is a diagram for illustrating a conditional minimum winning price probability distribution regarding one auction history according to an embodiment of the disclosure;

FIG. 8 is a diagram for illustrating a conditional minimum winning price probability distribution regarding one auction history according to an embodiment of the disclosure;

FIG. 9 is a diagram for illustrating a conditional minimum winning price probability distribution regarding one auction history according to an embodiment of the disclosure;

FIG. 10 is a sequence diagram for illustrating a method for an electronic apparatus to predict the minimum winning price by using auction attribute information according to an embodiment of the disclosure; and

FIG. 11 is a diagram for illustrating a method of controlling an electronic apparatus according to an embodiment of the disclosure.

### DETAILED DESCRIPTION

Various modifications may be made to the embodiments of the disclosure, and there may be various types of embodiments. Accordingly, specific embodiments will be illustrated in drawings, and the embodiments will be described in detail in the detailed description. However, it should be noted that the various embodiments are not for limiting the scope of the disclosure to a specific embodiment, but they should be interpreted to include various modifications, equivalents, and/or alternatives of the embodiments of the disclosure. Also, with respect to the detailed description of the drawings, similar components may be designated by similar reference numerals.

Also, in describing the disclosure, in case it is determined that detailed explanation of related known functions or features may unnecessarily confuse the gist of the disclosure, the detailed explanation will be omitted.

In addition, the embodiments described below may be modified in various different forms, and the scope of the technical idea of the disclosure is not limited to the embodiments below. Rather, these embodiments are provided to make the disclosure more sufficient and complete, and to fully convey the technical idea of the disclosure to those skilled in the art.

Also, the terms used in the disclosure are used only to explain specific embodiments, and are not intended to limit the scope of the disclosure. Further, singular expressions include plural expressions, unless defined obviously differently in the context.

In addition, in the disclosure, expressions such as “have,” “may have,” “include,” and “may include” denote the existence of such characteristics (e.g.: elements such as numbers, functions, operations, and components), and do not exclude the existence of additional characteristics.

Also, in the disclosure, the expressions “A or B,” “at least one of A and/or B,” or “one or more of A and/or B” and the like may include all possible combinations of the listed items. For example, “A or B,” “at least one of A and B,” or “at least one of A or B” may refer to all of the following cases: (1) including at least one A, (2) including at least one B, or (3) including at least one A and at least one B.

In addition, the expressions “first,” “second,” and the like used in the disclosure may describe various elements regardless of any order and/or degree of importance. Also, such expressions are used only to distinguish one element from another element, and are not intended to limit the elements.

Meanwhile, the description in the disclosure that one element (e.g.: a first element) is “(operatively or communicatively) coupled with/to” or “connected to” another element (e.g.: a second element) should be interpreted to include both the case where the one element is directly coupled to the another element, and the case where the one element is coupled to the another element through still another element (e.g.: a third element).

In contrast, the description that one element (e.g.: a first element) is “directly coupled” or “directly connected” to another element (e.g.: a second element) can be interpreted to mean that still another element (e.g.: a third element) does not exist between the one element and the another element.

Also, the expression “configured to” used in the disclosure may be interchangeably used with other expressions such as “suitable for,” “having the capacity to,” “designed to,” “adapted to,” “made to,” and “capable of,” depending on cases. Meanwhile, the term “configured to” does not necessarily mean that an apparatus is “specifically designed to” in terms of hardware.

Instead, under some circumstances, the expression “an apparatus configured to” may mean that the apparatus “is capable of” performing an operation together with another apparatus or component. For example, the phrase “a processor configured to perform A, B, and C” may mean a dedicated processor (e.g.: an embedded processor) for performing the corresponding operations, or a generic-purpose processor (e.g.: a CPU or an application processor) that can perform the corresponding operations by executing one or more software programs stored in a memory apparatus.

Further, in the embodiments of the disclosure, ‘a module’ or ‘a part’ may perform at least one function or operation, and may be implemented as hardware or software, or as a combination of hardware and software. Also, a plurality of ‘modules’ or ‘parts’ may be integrated into at least one module and implemented as at least one processor, excluding ‘a module’ or ‘a part’ that needs to be implemented as specific hardware.

Meanwhile, various elements and areas in the drawings were illustrated schematically. Accordingly, the technical idea of the disclosure is not limited by the relative sizes or intervals illustrated in the accompanying drawings.

Hereinafter, the embodiments according to the disclosure will be described in detail with reference to the accompanying drawings, such that those having ordinary skill in the art to which the disclosure belongs can easily carry out the disclosure.

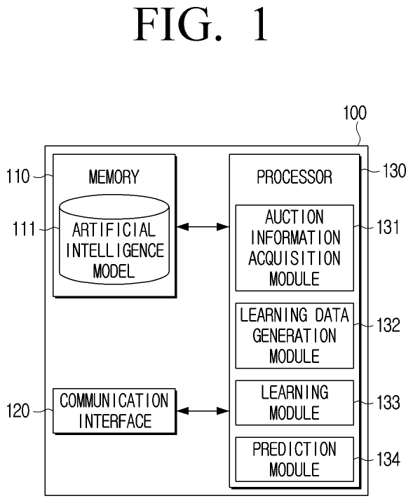

FIG. 1 is a block diagram for illustrating a configuration of an electronic apparatus according to an embodiment of the disclosure.

The electronic apparatus 100 may include a memory 110, a communication interface 120, and a processor 130. In the electronic apparatus 100, some of the above components may be omitted, or other components may be further included.

Also, the electronic apparatus 100 may be implemented as a server, but it may also be implemented in various forms such as a smartphone, a mobile phone, earphones, a headset, a personal digital assistant (PDA), a laptop, a media player, an e-book reader, a terminal for digital broadcasting, a navigation, a kiosk, an MP3 player, a digital camera, a wearable apparatus, home appliances, and other mobile or non-mobile computing apparatuses, etc.

The memory 110 may store at least one instruction related to the electronic apparatus 100. The memory 110 may store an operating system (O/S) for driving the electronic apparatus 100. Also, the memory 110 may store various kinds of software programs or applications for the electronic apparatus 100 to operate according to the various embodiments of the disclosure. Further, the memory 110 may include a semiconductor memory such as a flash memory or a magnetic storage medium such as a hard disk.

Specifically, the memory 110 may store various kinds of software modules for the electronic apparatus 100 to operate according to the various embodiments of the disclosure, and the processor 130 may control the operation of the electronic apparatus 100 by executing the various kinds of software modules stored in the memory 110. That is, the memory 110 may be accessed by the processor 130, and reading/recording/correcting/deleting/updating, etc. of data by the processor 130 may be performed.

Meanwhile, in the disclosure, the term memory 110 may be used as meaning including the memory 110, a ROM (not shown) and a RAM (not shown) inside the processor 130, or a memory card (not shown) (e.g., a micro SD card, a memory stick) mounted on the electronic apparatus 100.

In addition, the memory 110 may store an artificial intelligence model 111. Here, the artificial intelligence model 111 may be an artificial intelligence model which, when auction attribute information for a real-time advertisement auction is input, outputs information on the minimum winning price, or predicts the minimum winning price.

Here, the auction attribute information for the real-time advertisement auction may include at least one of information on the auction, information on the advertisement, information on a user who accessed the publisher online providing the advertisement, or information on the publisher providing the advertisement.

Here, the information on the auction may include information on the auction type. Here, the auction type may be a first-price auction (FPA) or a second-price auction (SPA). The FPA may be a method wherein a bidder who suggested the highest bid price among all bid prices suggested in the auction is chosen as the winner, and the winner pays the highest bid price (i.e., the bid price suggested by the advertiser) among the entire bid prices as the winning price. Also, the SPA may be a method wherein an advertiser who suggested the highest bid price among all bid prices suggested in the auction is chosen as the winner, and the winner pays the second highest bid price (or a price which corresponds to addition of a predetermined price to the second highest price) among the entire bid prices as the winning price.

Also, the information on the advertisement may include information on at least one of the advertiser, the advertisement area, or a user's preference for the advertisement area. Here, the information on the advertisement area may include information on at least one of the type of the advertisement area (e.g.: a banner advertisement, a pop-up advertisement, a search advertisement, etc.), the size of the advertisement area (e.g.: 200 horizontal pixels and 150 vertical pixels, etc.), the location of the advertisement area, or the type of the advertising content posted in the advertisement area (e.g.: a moving image, an image, a keyword, etc.).

Also, the information on the user may include information on at least one of the user's access IP, the user's sex, the user's date of birth (or age, etc.), the user's location (e.g.: the current location, the residence, the nationality, etc.), the user's access time, the terminal device used by the user (e.g., the type of the terminal device, etc.), whether general data protection regulation (GDPR) is used by the user (e.g., whether the user agreed to provide personal information and the scope of provision of the user's personal information), whether the user clicked the advertisement, the user's search keyword, information on the publisher, or the user's preference for the advertisement area.

Further, the information on the publisher may include information on at least one of the type of the publisher that the user accessed (e.g.: a news feed, a PC application, a mobile application, a messenger, a banner), the category of the publisher (e.g.: shopping, electronic goods, SNS, games, automobiles, finance, etc.) or the service provider of the publisher (e.g.: Samsung Electronics, etc.).

Also, the minimum winning price may mean the price which is the lowest among the bid prices that can win an auction.

Further, the information on the minimum winning price may be the minimum winning price probability distribution. The minimum winning price probability distribution may be a probability distribution indicating the probability that a specific bid price is the minimum winning price.

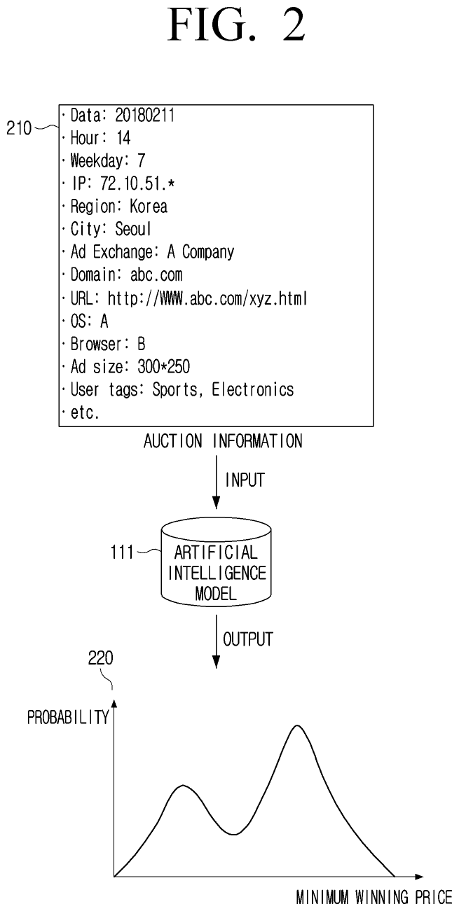

For example, as illustrated in FIG. 2, when the auction attribute information 210 for a real-time advertisement auction is input, the artificial intelligence model 111 may output the minimum winning price probability distribution 220. Here, as illustrated in FIG. 2, the auction attribute information 210 may include information on the date, the time, the user's access IP, the user's location, the advertiser, the domain, the access URL, the OS of the user's terminal device, the user's access browser, the size of the advertisement area, etc.

Also, the communication interface 120 includes circuitry, and it is a component that can communicate with an external apparatus and a server. The communication interface 120 may perform communication with an external apparatus or a server based on a wired or wireless communication method. The communication interface 120 may include a Bluetooth module (not shown), a Wi-Fi module (not shown), an infrared (IR) module, a local area network (LAN) module, an Ethernet module, etc. Here, each communication module may be implemented in the form of at least one hardware chip. The wireless communication module may include at least one communication chip that performs communication according to various wireless communication protocols such as Zigbee, a universal serial bus (USB), a mobile industry processor interface camera serial interface (MIPI CSI), 3rd generation (3G), 3rd generation partnership project (3GPP), Long Term Evolution (LTE), LTE Advanced (LTE-A), 4th Generation (4G), 5th Generation (5G), etc. other than the aforementioned communication methods. However, this is merely an example, and the communication interface 120 may use at least one communication module among various communication modules.

The processor 130 may control the overall operations and functions of the electronic apparatus 100. Specifically, the processor 130 is connected with the components of the electronic apparatus 100 including the memory 110, and may control the overall operations of the electronic apparatus 100 by executing at least one instruction stored in the memory 110 as described above.

The processor 130 may be implemented in various ways. For example, the processor 130 may be implemented as at least one of an application specific integrated circuit (ASIC), an embedded processor, a microprocessor, a hardware control logic, a hardware finite state machine (FSM), or a digital signal processor (DSP). Meanwhile, in the disclosure, the term processor 130 may be used as meaning including a central processing unit (CPU), a graphic processing unit (GPU), and a main processing unit (MPU), etc.

The operations of the processor 130 for implementing the various embodiments of the disclosure may be implemented through the artificial intelligence model 111 and a plurality of modules.

Specifically, data regarding the artificial intelligence model 111 and the plurality of modules according to the disclosure may be stored in the memory 110, and the processor 130 may access the memory 110, and load the data regarding the artificial intelligence model 111 and the plurality of modules in a memory or a buffer inside the processor 130, and then implement the various embodiments according to the disclosure by using the artificial intelligence model 111 and the plurality of modules. Here, the plurality of modules may include an auction information acquisition module 131, a learning data generation module 132, a learning module 133, and a prediction module 134.

Meanwhile, at least one of the artificial intelligence model 111 or the plurality of modules according to the disclosure may be implemented as hardware, and may be included inside the processor 130 in a form of a system on chip.

The auction information acquisition module 131 may acquire information on a plurality of auction histories. For example, the auction information acquisition module 131 may acquire information on a plurality of auction histories through the communication interface 120.

Alternatively, the electronic apparatus 100 may participate in a real-time advertisement auction, and store information on the advertisement auction history in the memory 110. Here, the auction information acquisition module 131 may acquire information on the plurality of auction histories stored in the memory 110.

Here, the information on the auction histories may include at least one of information on auction attributes, information on bid prices, information on whether the auctions were won, or information on winning prices.

Also, the plurality of auction histories may include at least one auction history of a first auction type and at least one auction history of a second auction type.

Meanwhile, the first auction type may be a first-price auction (FPA), and the second auction type may be a second-price auction (SPA).

In the case of the FPA, the advertiser suggests the bid price that the advertiser suggested as the winning price when winning the auction, and thus there is a problem that the second highest bid price among the entire bid prices, i.e., the minimum winning price (the market price) cannot be identified. In contrast, when the advertiser loses the auction, there may be a problem that the advertiser can only identify the fact that a price that can win the auction is higher than the bid price by the advertiser, and the advertiser cannot identify the correct winning price.

Also, in the case of the SPA, the advertiser pays the second highest bid price among the entire bid prices as the winning price when winning the auction, and thus the advertiser can identify the minimum winning price. In contrast, when the advertiser loses the auction, there may be a problem that the advertiser can only identify the fact that a price that can win the auction is higher than the bid price by the advertiser, and the advertiser cannot identify the correct winning price.

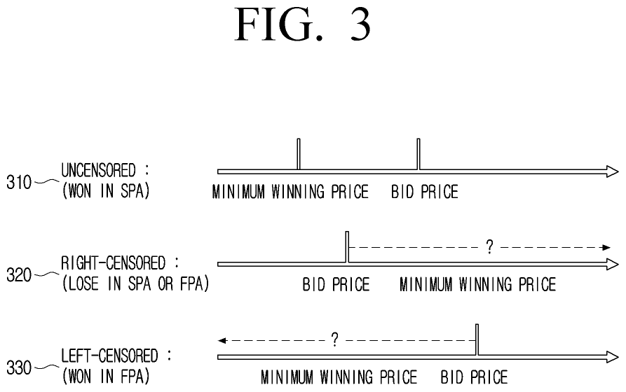

Specifically, referring to FIG. 3, the information on the auction histories may be divided into an uncensored auction history, a right-censored auction history, and a left-censored auction history. Here, the censoring may mean censoring for the minimum winning price. That is, the uncensored auction history 310 may be an auction history wherein the bid prices and the minimum winning price are known. Specifically, the uncensored auction history may be an auction history wherein bid winning succeeded in the SPA.

The right-censored auction history 320 and the left-censored auction history 330 may be auction histories wherein only the sections wherein the bid prices and the minimum winning prices exist are known, and the minimum winning prices are not known.

Here, the right-censored auction history 320 may mean an auction history wherein the minimum winning price is higher than the bid price, but the correct minimum winning price cannot be identified. In case bid winning failed in the FPA or the SPA, only the fact that the winning price is higher than the bid price can be identified, and the correct minimum winning price may not be identified.

Also, the left-censored auction history 330 may mean an auction history wherein the minimum winning price is lower than the bid price, but the correct minimum winning price cannot be identified. In case bid winning succeeded in the FPA, only the fact that the bid price is the highest among the entire bid prices can be identified, and the minimum winning price that is the second highest bid price among the entire bid prices may not be identified.

Further, the learning data generation module 132 may generate the minimum winning price probability distribution for entire of the plurality auction histories.

Specifically, the learning data generation module 132 may acquire information on a section wherein the winning price exists or a section wherein the winning price does not exist by using information on the at least one auction history of the second auction type. That is, in case bid winning failed in the second auction type, the section wherein the winning price exists may be a section exceeding the bid price, and the section wherein the winning price does not exist may be a section lower than or equal to the bid price. Also, the learning data generation module 132 may accumulate information on the section wherein the winning price exists or the section wherein the winning price does not exist, and generate a bid winning probability function according to the bid price.

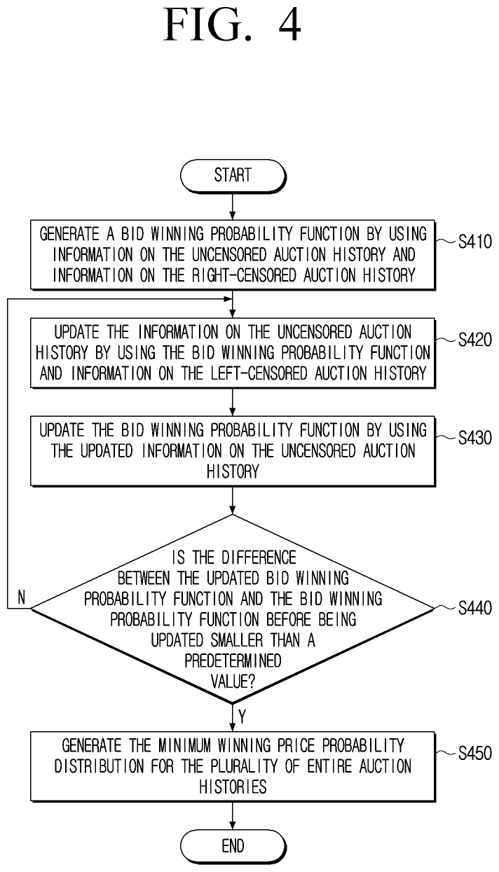

Specifically, referring to FIG. 4, the learning data generation module 132 may generate a bid winning probability function by using information on the uncensored auction history (i.e., the auction history wherein bid winning succeeded in the SPA type) and information on the right-censored auction history (i.e., the auction history wherein bid winning failed in the FPA type and the SPA type) among the plurality of auction histories in operation S410. Here, the learning data generation module 132 may generate the bid winning probability function by using a Kaplan Meier Estimation.

Here, the bid winning probability function may be a function indicating a winning probability for a specific bid price. That is, in the bid winning probability function, the x axis may mean the bid price, and the y axis may mean the winning probability.

For example, the bid winning probability function Wᵢ may be generated by the following formula 1.

$${W}_{i} = 1 - {S}_{i} = 1 - {\prod }_{{j < i}^{}} \frac{{n}_{j} - {δ}_{j}}{{n}_{j}} , {n}_{j} = {\sum }_{l = j}^{L} {λ}_{l} + {δ}_{l} \qquad [ Formula 1 ]$$

Here, Wᵢ may be the bid winning probability function for the bid price. sᵢ may be the bid failing probability for the bid price bᵢ. Also, nⱼ may mean the number of survival data in the jth price in price intervals in a j number, and L may mean the maximum value of the bid price. Here, the survival data may mean information on an auction history wherein the right-censored price is lower than or equal to a specific bid price based on the specific bid price. Also, λ may mean right-censored data, and δ may mean uncensored data.

Then, when the bid winning probability function is generated, the learning data generation module 132 may update the information on the uncensored auction history (i.e., the auction history wherein bid winning succeeded in the SPA type) by using the bid winning probability function and the left-censored auction history (i.e., the auction history wherein bid winning succeeded in the FPA type) in operation S420. For example, the uncensored auction history may be updated by the following formula 2.

$${δ}_{j}^{( m )} = {δ}_{j}^{( 0 )} + {\sum }_{l = j}^{L} {μ}_{l} + {α}_{lj} , \text{} 1 \leq j \leq L , \text{} {α}_{lj} = \frac{{W}_{j}^{( m - 1 )} - {W}_{j - 1}^{( m - 1 )}}{{W}_{l}^{( m - 1 )}} , all l \leq j \qquad [ Formula 2 ]$$

Here, m may mean the number of times that the bid winning probability function was updated. That is, in case there is no history that the bid winning probability function was updated, m may be 1.

Also, μ may mean left-censored data, and α may mean the weight. Here, the weight α may be a value that was acquired by differentiating W^{(m-1)} in the previous step.

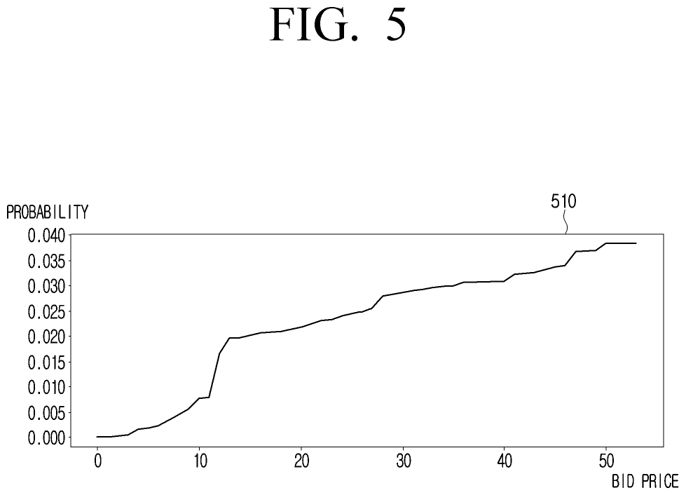

Then, the learning data generation module 132 may update the bid winning probability function by using the updated information on the uncensored auction history in operation S430. Here, the updated bid winning probability function may be the cumulative distribution function illustrated in FIG. 5.

For example, the bid winning probability function Wᵢ^{(m)} that was updated for the mth times may be updated by the following formula 3.

$${W}_{i}^{( m )} = 1 - {\prod }_{{j < 1}^{}} \frac{{n}_{j}^{( m )} - {δ}_{j}^{( m )}}{{n}_{j}^{( m )}} , {n}_{j}^{( m )} = {\sum }_{l = j}^{L} {λ}_{l} + {δ}_{l}^{( m )} \qquad [ Formula 3 ]$$

That is, Wᵢ^{(m)} may be generated by δ^{(m)} which is the information on the uncensored auction history δ updated for the mth times.

Then, when the bid winning probability function is updated, the learning data generation module 132 may identify whether the difference between the updated bid winning probability function and the bid winning probability function before being updated is smaller than a predetermined value in operation S440. That is, the learning data generation module 132 may identify whether the difference between Wᵢ^{(m)} and Wᵢ^{(m-1)} is lower than a predetermined value.

If it is identified that the difference between the updated bid winning probability function and the bid winning probability function before being updated is higher than or equal to the predetermined value in operation S440—N, the learning data generation module 132 may update the information on the uncensored auction history by using the updated bid winning probability function and the information on the left-censored auction history in operation S420. Here, the bid winning probability function may be the updated bid winning probability function.

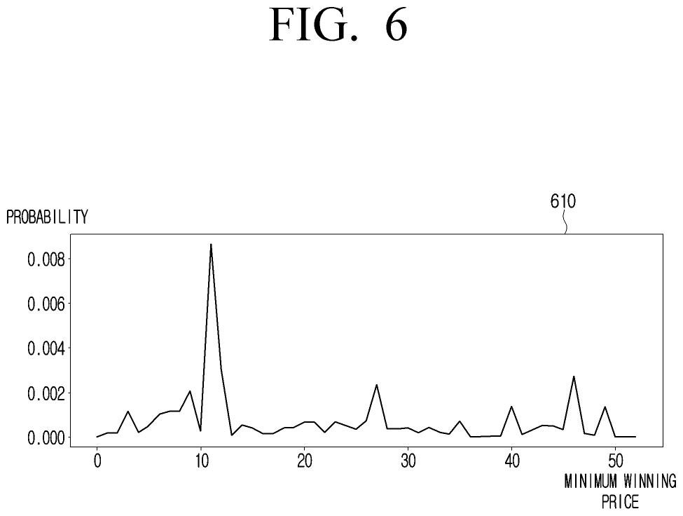

Meanwhile, if it is identified that the difference between the updated bid winning probability function and the bid winning probability function before being updated is lower than the predetermined value in operation S440—Y, the learning data generation module 132 may generate the minimum winning price probability distribution for entire of the plurality auction histories by using the bid winning probability function in operation S450. Here, the generated minimum winning price probability distribution may be the same as the probability distribution function illustrated in FIG. 6.

Then, based on the minimum winning price probability distribution for entire of the plurality auction histories, the learning data generation module 132 may generate a conditional minimum winning price probability distribution for each of the plurality of auction histories.

Specifically, each of the plurality of auction histories may be one of a case wherein bid winning succeeded in the first auction type, a case wherein bid winning failed in the first auction type, a case wherein bid winning succeeded in the second auction type, or a case wherein bid winning failed in the second auction type.

That is, one auction history among the plurality of auction histories may be an auction history wherein bid winning succeeded in the first auction type. Here, the minimum winning price in the auction history wherein bid winning succeeded in the first auction type may be lower than the bid price. Here, the probability that a price higher than or equal to the bid price may win the auction may be 0.

Accordingly, if one auction history among the plurality of auction histories is an auction history wherein bid winning succeeded in the first auction type, the learning data generation module 132 may generate a conditional minimum winning price probability distribution for the one auction history by using a probability value for a price higher than or equal to the bid price included in the information on the one auction history as 0 in the minimum winning price probability distribution for entire of the plurality auction histories.

For example, one auction history among the plurality of auction histories may be an auction history wherein bid winning succeeded at 43 won in the first auction type. Here, the minimum winning price may be lower than 43 won. Accordingly, the probability that the minimum winning price is higher than 43 won may be 0.

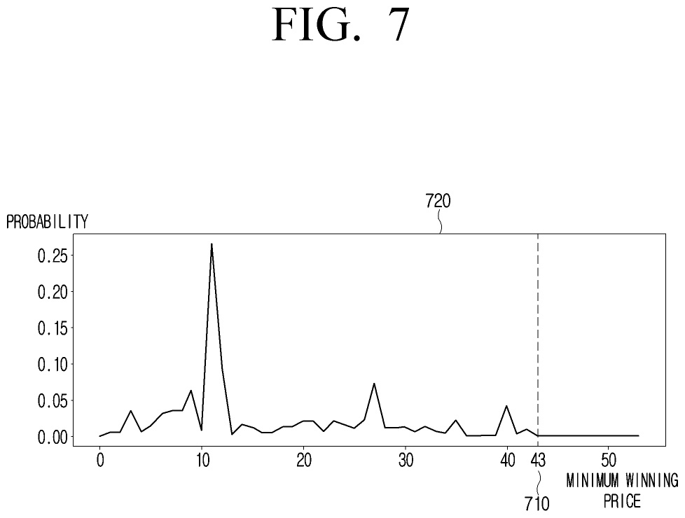

Accordingly, as illustrated in FIG. 7, the learning data generation module 132 may generate a conditional minimum winning price probability distribution 720 for the one auction history by using a probability value for a price higher than or equal to the bid price 43 won 710 as 0 in the minimum winning price probability distribution 610. Here, the generated conditional minimum winning price probability distribution 720 may be a probability distribution that was upscaled such that the entire integration value becomes 1.

Also, one auction history among the plurality of auction histories may be an auction history wherein bid winning succeeded in the second auction type. Here, in the second auction type, the winner pays the second highest bid price among the entire bid prices as the winning price, and thus the winning price may be the minimum winning price.

Accordingly, if one auction history among the plurality of auction histories is an auction history wherein bid winning succeeded in the second auction type, the learning data generation module 132 may generate a conditional minimum winning price probability distribution for the one auction history by using a probability value for the winning price included in the information on the one auction history as 1 in the minimum winning price probability distribution for entire of the plurality auction histories.

For example, one auction history among the plurality of auction histories may be an auction history wherein 70 won was the bid price, and 43 won was paid as the winning price in the second auction type. Here, the minimum winning price may be 43 won that was paid as the winning price. Here, the probability that the winning price is 43 won may be 1, and the probability that the winning price is not 43 won may be 0.

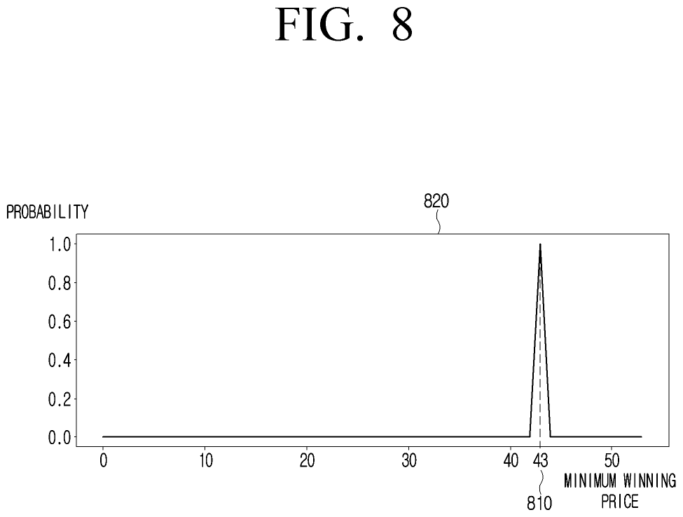

Accordingly, as illustrated in FIG. 8, the learning data generation module 132 may generate a conditional minimum winning price probability distribution 820 for the one auction history by using a probability value at the winning price 43 won 810 as 1 in the minimum winning price probability distribution 610. Here, the generated conditional minimum winning price probability distribution 820 may be a probability distribution that was upscaled such that the entire integration value becomes 1.

Also, one auction history among the plurality of auction histories may be an auction history wherein bid winning failed in the first auction type or the second auction type. Here, in case the bid winning failed, the winning price may be a value that exceeds the bid price. Here, the probability that a price lower than or equal to the bid price is the minimum winning price may be 0.

Accordingly, if one auction history among the plurality of auction histories is an auction history wherein bid winning failed in the first auction type or the second auction type, the learning data generation module 132 may generate a conditional minimum winning price probability distribution for the one auction history by using a probability value for a price lower than or equal to the bid price as 0 in the minimum winning price probability distribution for entire of the plurality auction histories.

For example, one auction history among the plurality of auction histories may be an auction history wherein 26 won was the bid price and bid winning failed in the FPA type or the SPA type.

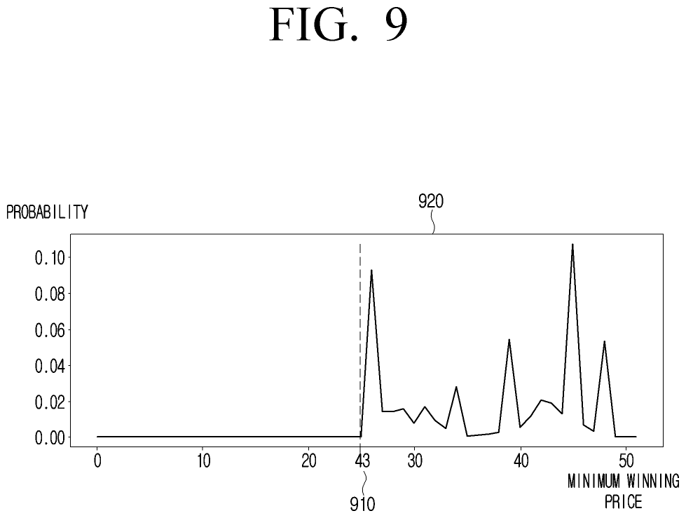

Accordingly, as illustrated in FIG. 9, the learning data generation module 132 may generate a conditional minimum winning price probability distribution 920 for the one auction history by using a probability value at lower than or equal to the bid price 26 won 910 as 0 in the minimum winning price probability distribution 610. Here, the generated conditional minimum winning price probability distribution 920 may be a probability distribution that was upscaled such that the entire integration value becomes 1.

Then, the artificial intelligence learning model 133 may train the artificial intelligence model 111 by using auction attribute information for each of the plurality of auction histories as an independent variable, and using the conditional minimum winning price probability distribution for each of the plurality of auction histories as a dependent variable.

That is, the artificial intelligence learning model 133 may label the auction attribute information for each of the plurality of auction histories with the conditional minimum winning price probability distribution for each of the plurality of auction histories. Then, the artificial intelligence learning model 133 may train the artificial intelligence model 111 so that the difference between the conditional minimum winning price probability distribution predicted for each of the plurality of auction histories and the conditional minimum winning price probability distribution labeled for each of the plurality of auction histories becomes minimum.

Here, the difference between the predicted conditional minimum winning price probability distribution and the labeled conditional minimum winning price probability distribution may be defined by a loss function using a Kullback-Leibler Divergence (KLD). However, the disclosure is not limited thereto, and the difference between the predicted conditional minimum winning price probability distribution and the labeled conditional minimum winning price probability distribution may be defined by various technics for evaluating the difference between the two probability distributions.

Based on the trained artificial intelligence model, the winning price prediction module 134 may predict the minimum winning price by using auction attribute information.

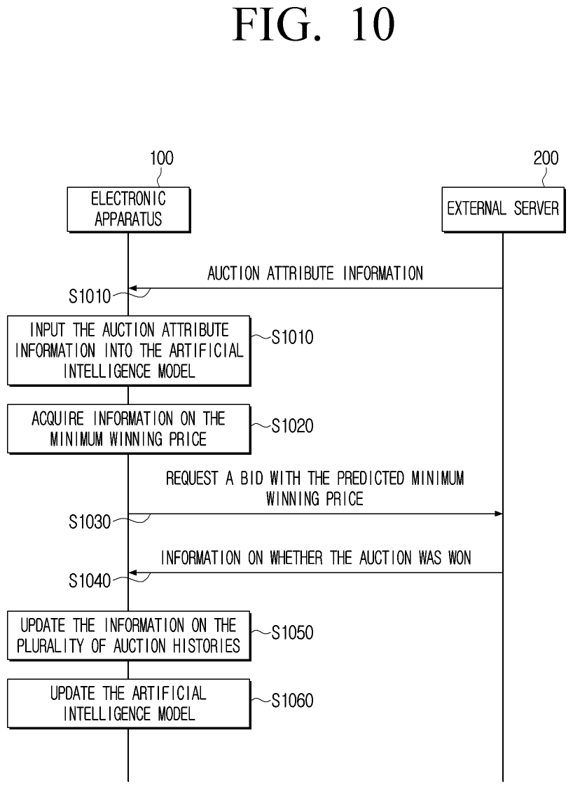

Specifically, referring to FIG. 10, the winning price prediction module 134 may acquire auction attribute information from an external server 200 in operation S1010. Here, the external server 200 may be a server providing an advertising content to a user or a server mediating a trade for an advertisement by a real-time auction method.

When the auction attribute information is acquired, the winning price prediction module 134 may input the auction attribute information into the artificial intelligence model 111 in operation S1020, and acquire information on a minimum winning price in operation S1030. Here, the information on the minimum winning price may be a minimum winning price probability distribution. Alternatively, the information on the minimum winning price may be the price having the highest probability in the minimum winning price probability distribution.

When the minimum winning price is predicted, the winning price prediction module 134 may transmit information for bidding with the predicted minimum winning price to the external server 200 in operation S1030.

Alternatively, the winning price prediction module 134 may acquire a final bid price by using the predicted minimum winning price and information related to the advertisement. Here, the information related to the advertisement may be information regarding at least one of the advertisement profit, the advertisement budget, or the advertisement purpose. Here, the advertisement profit may mean the profit predicted from the auction attribute. Also, the advertisement budget may mean the budget that can be invested in a real-time auction. Further, the advertisement purpose may be the purpose for achieving through a real-time auction (e.g., 1000 or more times of success of bid winning). For example, the winning price prediction module 134 may acquire the final bid price by inputting the predicted minimum winning price and the information related to the advertisement into a second artificial intelligence model. Then, the winning price prediction module 134 may transmit the acquired final bid price to the external server 200. Here, the second artificial intelligence model may be stored in the memory 110.

Then, the external server 200 may determine the winner based on the received bid price, and transmit information whether the auction was won to the electronic apparatus 100 in operation S1040. Here, the information on whether the auction was won may include information on the winning price together when bid winning succeeded in the SPA type.

Then, the electronic apparatus 100 may update the information on the plurality of auction histories based on the received information on whether the auction was won in operation S1050. That is, the electronic apparatus 100 may add the received auction attribute information, the transmitted information on the bid price, and the received information on whether the auction was won to the information on the plurality of auction histories.

Then, the electronic apparatus 100 may update the artificial intelligence model 111 based on the updated information on the plurality of auction histories 1060. Accordingly, the electronic apparatus 100 can continuously improve the performance of predicting the minimum winning price while participating in a real-time advertisement auction.

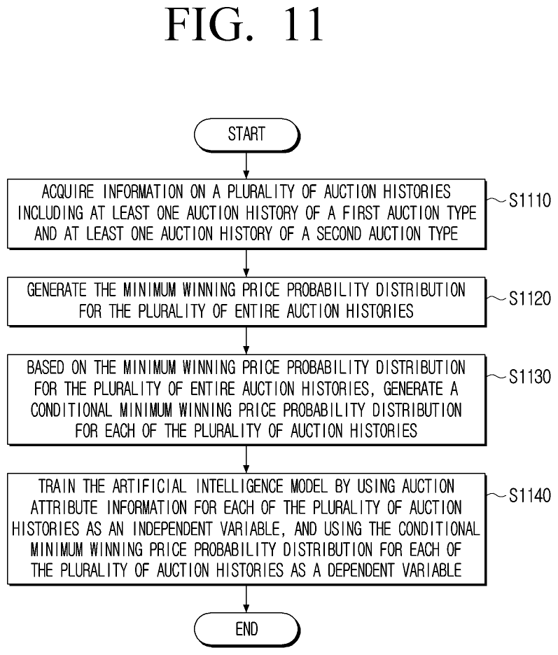

FIG. 11 is a diagram for illustrating a method of controlling the electronic apparatus 100 according to an embodiment of the disclosure.

The electronic apparatus 100 may acquire information on a plurality of auction histories including at least one auction history of a first auction type and at least one auction history of a second auction type in operation S1110.

Then, the electronic apparatus 100 may generate the minimum winning price probability distribution for entire of the plurality auction histories in operation S1120.

Then, the electronic apparatus 100 may generate a conditional minimum winning price probability distribution for each of the plurality of auction histories based on the minimum winning price probability distribution for entire of the plurality auction histories in operation S1130.

Then, the electronic apparatus 100 may train the artificial intelligence model by using auction attribute information for each of the plurality of auction histories as an independent variable, and using the conditional minimum winning price probability distribution for each of the plurality of auction histories as a dependent variable in operation S1140.

Meanwhile, functions related to artificial intelligence according to the disclosure may be operated through the processor 130 and the memory 110 of the electronic apparatus 100.

The processor 130 may consist of one or a plurality of processors. Here, the one or plurality of processors may be generic-purpose processors such as a central processing unit (CPU) and an application processor (AP), etc., graphic-dedicated processors such as a graphic processing unit (GPU) and a vision processing unit (VPU), etc., or artificial intelligence-dedicated processors such as a neural processing unit (NPU) and a tensor processing unit (TPU).

According to an embodiment of the disclosure, in case a plurality of processors are included in the System on Chip (SoC) included in the electronic apparatus 100, the electronic apparatus 100 may perform an operation related to artificial intelligence (e.g., an operation related to learning or inference of the artificial intelligence model) by using a graphic-dedicated processor or an artificial intelligence-dedicated processor among the plurality of processors, and perform a general operation of the electronic apparatus by using a generic-purpose processor among the plurality of processors. For example, the electronic apparatus 100 may perform an operation related to artificial intelligence by using at least one of a GPU, a VPU, an NPU, or a TPU specified for a convolution operation among the plurality of processors, and perform a general operation of the electronic apparatus 100 by using at least one of a CPU or an AP among the plurality of processors.

Also, the electronic apparatus 100 may perform an operation for a function related to artificial intelligence by using a multi core (e.g., a dual core, a quad core, etc.) included in one processor. In particular, the electronic apparatus may perform a convolution operation in parallel by using the multi core included in the processor. The one or plurality of processors perform control to process input data according to predefined operation rules or an artificial intelligence model stored in the memory. The predefined operation rules or the artificial intelligence model are characterized in that they are made through learning.

Here, being made through learning means that predefined operations rules or an artificial intelligence model having desired characteristics are made by applying a learning algorithm to a plurality of learning data. Such learning may be performed in an apparatus itself wherein artificial intelligence is performed according to the disclosure, or through a separate server/system.

The artificial intelligence model 111 may consist of a plurality of neural network layers. Each layer has a plurality of weight values, and performs an operation of the layer through the operation result of the previous layer and an operation of the plurality of weight values. As examples of neural networks, there are a convolutional neural network (CNN), a deep neural network (DNN), a recurrent neural network (RNN), a restricted Boltzmann Machine (RBM), a deep belief network (DBN), a bidirectional recurrent deep neural network (BRDNN) and deep Q-networks, and a Transformer, but neural networks in the disclosure are not limited to the aforementioned examples excluding specified cases.

A learning algorithm is a method of training a specific subject apparatus (e.g., a robot) by using a plurality of learning data and thereby making the specific subject apparatus make a decision or make prediction by itself. As examples of learning algorithms, there are supervised learning, unsupervised learning, semi-supervised learning, or reinforcement learning, but learning algorithms in the disclosure are not limited to the aforementioned examples excluding specified cases.

Meanwhile, the term “a part” or “a module” used in the disclosure may include a unit implemented as hardware, software, or firmware, and may be interchangeably used with, for example, terms such as a logic, a logical block, a component, or a circuit. In addition, “a part” or “a module” may be a component constituted as an integrated body or a minimum unit or a part thereof performing one or more functions. For example, a module may be constituted as an application-specific integrated circuit (ASIC).

Also, the various embodiments of the disclosure may be implemented as software including instructions stored in machine-readable storage media, which can be read by machines (e.g.: computers). The machines refer to apparatuses that call instructions stored in a storage medium, and can operate according to the called instructions, and the apparatuses may include the electronic apparatus 100 according to the aforementioned embodiments. In case an instruction is executed by a processor, the processor may perform a function corresponding to the instruction by itself, or by using other components under its control. An instruction may include a code that is generated or executed by a compiler or an interpreter. A storage medium that is readable by machines may be provided in the form of a non-transitory storage medium. Here, the term ‘non-transitory’ only means that a storage medium does not include signals, and is tangible, but does not indicate whether data is stored in the storage medium semi-permanently or temporarily.

In addition, according to an embodiment, methods according to the various embodiments disclosed herein may be provided while being included in a computer program product. A computer program product refers to a product, and it can be traded between a seller and a buyer. A computer program product can be distributed in the form of a storage medium that is readable by machines (e.g.: a compact disc read only memory (CD-ROM)), or distributed on-line through an application store (e.g.: Play Store™). In the case of on-line distribution, at least a portion of a computer program product may be stored in a storage medium such as the server of the manufacturer, the server of the application store, and the memory of the relay server at least temporarily, or may be generated temporarily.

Further, each of the components (e.g.: a module or a program) according to the various embodiments may consist of a singular object or a plurality of objects. Also, among the aforementioned corresponding sub components, some sub components may be omitted, or other sub components may be further included in the various embodiments. Alternatively or additionally, some components (e.g.: a module or a program) may be integrated as an object, and perform functions performed by each of the components before integration identically or in a similar manner. In addition, operations performed by a module, a program, or other components according to the various embodiments may be executed sequentially, in parallel, repetitively, or heuristically. Or, at least some of the operations may be executed in a different order or omitted, or other operations may be added.

What is claimed is:

1. An electronic apparatus for training an artificial intelligence model that predicts a minimum winning price in a real time bidding, the electronic apparatus comprising:
a memory storing an artificial intelligence model and at least one instruction; and
a processor electronically connected to the memory and controlling the electronic apparatus,
wherein the processor is configured to, by executing the at least one instruction,
acquire information on a plurality of auction histories including information on at least one auction history of a first auction type and information on at least one auction history of a second auction type,
generate a minimum winning price probability distribution for all of the plurality of auction histories,
based on the minimum winning price probability distribution, generate a conditional minimum winning price probability distribution for each of the plurality of auction histories, and
train the artificial intelligence model by using an auction attribute information for each of the plurality of auction histories as an independent variable, and using the conditional minimum winning price probability distribution for each of the plurality of auction histories as a dependent variable.

2. The electronic apparatus of claim 1,
wherein the first auction type is a first-price auction, and the second auction type is a second-price auction.

3. The electronic apparatus of claim 1,
wherein the information on the plurality of auction histories comprises:
at least one of the auction attribute information, information on bid prices, information on whether respective auctions were won, or information on winning prices, and
the auction attribute information comprises:
at least one of information on auction types, information on advertisements, or information on users.

4. The electronic apparatus of claim 1,
wherein the processor is configured to:
acquire information on a section wherein the minimum winning price exists from each of the information on the at least one auction history of the second auction type, and
based on the acquired information on the section, generate the minimum winning price probability distribution for all of the plurality of auction histories.

5. The electronic apparatus of claim 4,
wherein the processor is configured to:
accumulate the acquired information on the section, and generate a bid winning probability function for a bid price,
based on the information on the at least one auction history of the first auction type, update the bid winning probability function, and
based on the updated bid winning probability function, generate the minimum winning price probability distribution for all of the plurality of auction histories.

6. The electronic apparatus of claim 1,
wherein the processor is configured to:
based on a first auction history among the plurality of auction histories being an auction history with a winning bid in the first auction type, acquire a first conditional minimum winning price probability distribution for the first auction history by using a probability value for a price higher than or equal to the winning bid as 0 in the minimum winning price probability distribution for all of the plurality of auction histories.

7. The electronic apparatus of claim 1,
wherein the processor is configured to:
based on a second auction history among the plurality of auction histories being an auction history with a winning bid in the second auction type, acquire a second conditional minimum winning price probability distribution for the second auction history by using a probability value for the winning bid as 1 in the minimum winning price probability distribution for all of the plurality of auction histories.

8. The electronic apparatus of claim 1,
wherein the processor is configured to:
based on a third auction history among the plurality of auction histories being an auction history with a losing bid in the first auction type or the second auction type, acquire a third conditional minimum winning price probability distribution for the third auction history by using a probability value for a price lower than or equal to the losing bid as 0 in the minimum winning price probability distribution for all of the plurality of auction histories.

9. A method for training an artificial intelligence model predicting a minimum winning price in a real time bidding, the method being executed by at least one processor, the method comprising:
acquiring information on a plurality of auction histories including information on at least one auction history of a first auction type and information on at least one auction history of a second auction type;
generating a minimum winning price probability distribution for all of the plurality of auction histories;
based on the minimum winning price probability distribution for all of the plurality of auction histories, generating a conditional minimum winning price probability distribution for each of the plurality of auction histories; and
training the artificial intelligence model by using an auction attribute information for each of the plurality of auction histories as an independent variable, and using the conditional minimum winning price probability distribution for each of the plurality of auction histories as a dependent variable.

10. The method of claim 9,
wherein the first auction type is a first-price auction, and the second auction type is a second-price auction.

11. The method of claim 9,
wherein the information on the plurality of auction histories comprises:
at least one of the auction attribute information, information on a bid price, information on whether respective auctions were won, or information on a winning price, and
the auction attribute information comprises:
at least one of information on auction types, information on advertisements, or information on users.

12. The method of claim 9,
wherein the generating the minimum winning price probability distribution comprises:
acquiring information on a section wherein the minimum winning price exists from each of the information on the at least one auction history of the second auction type; and
based on the acquired information on the section, generating the minimum winning price probability distribution for all of the plurality of auction histories.

13. The method of claim 12,
wherein the generating the minimum winning price probability distribution comprises:
accumulating the acquired information on the section, and generating a bid winning probability function for a bid price;
based on the information on the at least one auction history of the first auction type, updating the bid winning probability function; and
based on the updated bid winning probability function, generating the minimum winning price probability distribution for all of the plurality of auction histories.

14. The method of claim 9,
wherein the generating the conditional minimum winning price probability distribution for each of the plurality of auction histories comprises:
based on a first auction history among the plurality of auction histories being an auction history with a winning bid in the first auction type, acquiring a first conditional minimum winning price probability distribution for the first auction history by using a probability value for a price higher than or equal to the winning bid as 0 in the minimum winning price probability distribution for entire of the plurality of auction histories.

15. A non-transitory computer-readable recording medium storing instructions for training an artificial intelligence model predicting a minimum winning price in a real time bidding, the instructions configured to cause at least one processor in an electronic apparatus to: acquire information on a plurality of auction histories including information on at least one auction history of a first auction type and information on at least one auction history of a second auction type;
generate a minimum winning price probability distribution for all of the plurality of auction histories;
based on the minimum winning price probability distribution for all of the plurality of auction histories, generate a conditional minimum winning price probability distribution for each of the plurality of auction histories; and
train the artificial intelligence model by using an auction attribute information for each of the plurality of auction histories as an independent variable, and using the conditional minimum winning price probability distribution for each of the plurality of auction histories as a dependent variable.

16. The non-transitory computer readable recording medium of claim 15,
wherein the first auction type is a first-price auction, and the second auction type is a second-price auction.

17. The non-transitory computer readable recording medium of claim 15,
wherein the information on the plurality of auction histories comprises:
at least one of the auction attribute information, information on a bid price, information on whether respective auctions were won, or information on a winning price, and
the auction attribute information comprises:
at least one of information on auction types, information on advertisements, or information on users.

18. The non-transitory computer readable recording medium of claim 15,
wherein the generating the minimum winning price probability distribution comprises:
acquiring information on a section wherein the minimum winning price exists from each of the information on the at least one auction history of the second auction type; and
based on the acquired information on the section, generating the minimum winning price probability distribution for all of the plurality of auction histories.

19. The non-transitory computer readable recording medium of claim 18,
wherein the generating the minimum winning price probability distribution comprises:
accumulating the acquired information on the section, and generating a bid winning probability function for a bid price;
based on the information on the at least one auction history of the first auction type, updating the bid winning probability function; and
based on the updated bid winning probability function, generating the minimum winning price probability distribution for all of the plurality of auction histories.

20. The non-transitory computer readable recording medium of claim 15,
wherein the generating the conditional minimum winning price probability distribution for each of the plurality of auction histories comprises:
based on a first auction history among the plurality of auction histories being an auction history with a winning bid in the first auction type, acquiring a first conditional minimum winning price probability distribution for the first auction history by using a probability value for a price higher than or equal to the winning bid as 0 in the minimum winning price probability distribution for entire of the plurality of auction histories.
